(19) United States
(12) Patent Application Publication
(10) Pub. No.: US 2011/0215755 A1
(43) Pub. Date: Sep. 8, 2011

(54) INSULATED CHARGING MAT FOR CONSUMER ELECTRONICS (CE) DEVICE

(75) Inventors: Paul Jin Hwang, San Diego, CA (US); Fredrik Carpio, San Diego, CA (US); Nikolaos Georgis, San Diego, CA (US); Benjamin Lo, San Diego, CA (US)

(73) Assignee: SONY CORPORATION

(21) Appl. No.: 12/715,575

(22) Filed: Mar. 2, 2010

(51) Int. Cl. H02J 7/00

(52) U.S. Cl. 320/108

(57) ABSTRACT

A charging mat for recharging a consumer electronics (CE) device placed thereon. The mat has a flat charging surface configured for supporting the CE device and an insulating layer opposed to the charging surface and positionable on a support surface while the CE device is disposed on the charging surface. The insulating layer has an R-value of at least three ft²⁻° F.-h/BTU per inch of thickness. A coupling device is closely juxtaposed with the charging surface and is configured to inductively and/or capacitively couple charge energy into a battery of the CE device when the CE device is positioned on the charging surface. A charge battery disposed between the charging surface and insulating layer provides charge energy to the coupling device.

### FIELD OF THE INVENTION

The present application is directed to thermally insulated charging mats for consumer electronics (CE) device.

### BACKGROUND OF THE INVENTION

A wide variety of CE devices such as wireless telephones, personal digital assistants (PDAs), laptop computers, etc. have been provided that leverage digital processing to provide a multiplicity of useful features to users. Such devices typically are battery-powered and consequently must be recharged.

As understood herein, recharging of such devices may be undertaken by placing a CE device on a mat containing circuitry for inductively or capacitively charging the battery inside the CE device. As also understood herein, a user may desire to place a mat on the user's lap or on a couch or other surface, dispose the CE device on the mat to charge the CE device, and use the CE device while charging. Present principles recognize that under these circumstances, heat build up in the charging mat can annoy or even injure a person who is supporting the mat with CE device on his lap. Likewise, a charging mat heated from charging might damage the surface of a table on which the mat is disposed.

### SUMMARY OF THE INVENTION

Accordingly, an apparatus includes a generally flat, parallelepiped-shaped charging mat defining a flat charging surface on which a consumer electronics (CE) device can be disposed to wirelessly recharge a battery in the CE device. The mat contains a rechargeable charge battery and a transformer connected to the charge battery. The transformer transforms ac power received through a jack from the ac grid into dc power for recharging the rechargeable charge battery. A coupling device receives electricity from the charge battery. The coupling device is closely juxtaposed with the charge surface such that energy from the charge battery is coupled through the coupling device into the CE device to wirelessly recharge the CE device. A bottom thermal layer of the mat establishes a thermal insulator with a thickness and material sufficient to insulate a surface on which the thermal layer is disposed from heat propagating from the CE device and internal charging components of the mat. Owing to the thermal layer, the charging mat can be placed on a user's lap and the CE device placed on the charging surface to charge the CE device while the device is being used, with the thermal layer advantageously shielding the user from heat from the CE device and charging mat.

In preferred embodiments the thermal layer has an R-value of at least three ft²⁻° F.-h/BTU per inch of thickness. The thermal layer may be differently colored than the charging surface to alert a user which surface to place the CE device on to charge it and which surface should be disposed on a table or a user's lap. Or, the thermal layer may be alpha-numerically labeled “this surface down” to alert a user which surface to place the CE device on to charge it and which surface should be disposed on a table or a user's lap. The thermal layer can be made of foam or fiberglass batting.

In example embodiments the charging surface is established by a plastic platen. The mat may include a processor controlling the transformer. The coupling device can include one or more coils which inductively couple charge energy from the charge battery into the CE device. In addition or alternatively, the coupling device can include one or more charge carriers that capacitively couple charging energy from the charge battery into the CE device. The processor may be disposed between the charge battery and charging surface.

In another aspect, an assembly includes a furniture component defining a top flat surface and a charging mat defining a charging surface and being disposed in a bay of the furniture component such that the charging surface is flush with the top flat surface. The charging mat is configured to wirelessly recharge a consumer electronics (CE) device placed thereon using inductive or capacitive coupling.

In another aspect, a charging mat is disclosed for recharging a consumer electronics (CE) device placed thereon. The mat has a flat charging surface configured for supporting the CE device and an insulating layer opposed to the charging surface and positionable on a support surface while the CE device is disposed on the charging surface. The insulating layer has an R-value of at least three ft²⁻° F.-h/BTU per inch of thickness. A coupling device is closely juxtaposed with the charging surface and is configured to inductively and/or capacitively couple charge energy into a battery of the CE device when the CE device is positioned on the charging surface. A charge battery disposed between the charging surface and insulating layer provides charge energy to the coupling device.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing internal components of the charging mat and CE device;

FIG. 2 is partial cross-sectional view as would be seen along the line 2-2 in FIG. 1, schematically depicting the electronic components of the charging mat; and

FIG. 3 is a perspective view of an alternate embodiment in which the charging mat is built into the top of a table or desk.

### DETAILED DESCRIPTION OF THE PREFERRED EMBODIMENT

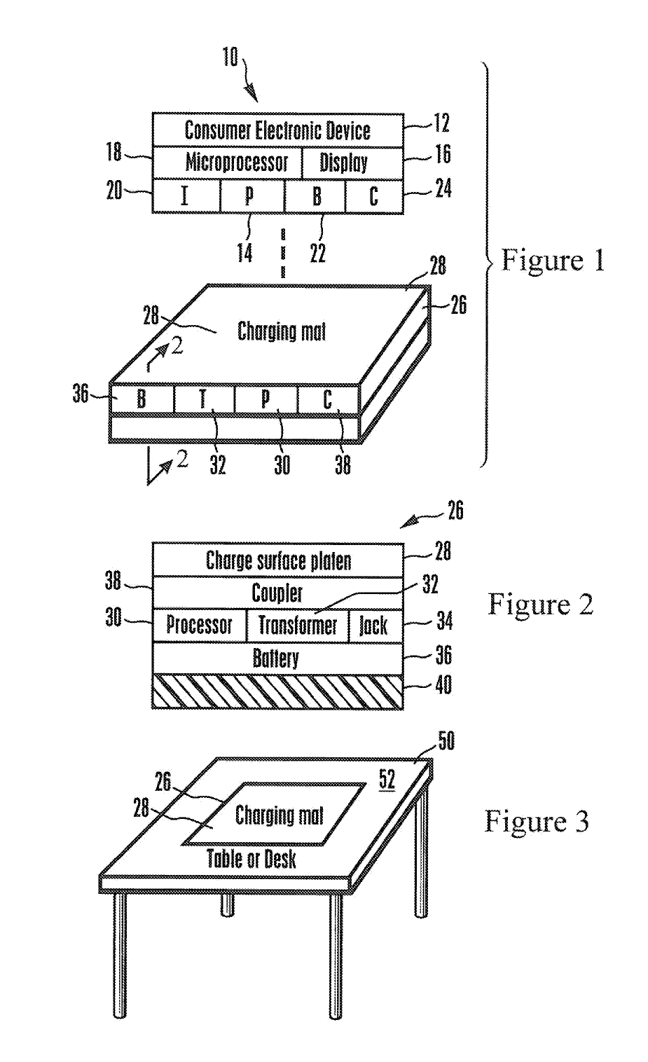

Referring initially to FIG. 1, a CE device 10 is shown that includes a housing 12 bearing a digital processor 14. The CE device 10 may be, e.g., a personal computer (PC) or laptop computer or notebook computer or personal digital assistant or intelligent telephone, although other digital processing apparatus are envisioned.

The processor 14 can control a visual display 16 and an audible display such as one or more speakers. The visual display 16 may be, e.g., a capacitive touchscreen display, although other display types may be used.

To undertake present principles, the processor 14 may access one or more computer readable storage media 18 such as but not limited to disk-based or solid state storage. The processor 14 may receive input from a user input device 20 such as but not limited to a keypad or a point-and-click device. The electronic components noted above may be energized by one or more rechargeable batteries 22 in the housing 12, which may be recharged by a coupling device 24 in the housing 12, discussed further below.

The CE device 10 may be disposed on a generally flat, parallelepiped-shaped charging mat 26 to wirelessly recharge the CE device battery 22. Specifically, the CE device 10 can be disposed on charging surface 28 of the charging mat 26, with the charging surface 28 in some embodiments being established by a plastic platen which may be flexible or rigid as desired.

As shown in cross-reference to FIGS. 1 and 2, the charging mat 26 includes a processor 30 controlling a transformer 32, typically an ac-dc transformer for transforming ac power received through a jack 34 from the ac grid into dc power for recharging a rechargeable charge battery 36. The charge battery 36 may be, e.g., a Lithium-based battery although other battery technologies may be used.

In turn, electricity from the charge battery 36 may be provided to a coupling device 38 which is closely juxtaposed with the charge surface 28 as shown. The coupling device 38 may include one or more coils which inductively couple charge energy into the coupling device 24 of the CE device 10. Or, the coupling device 38 may include one or more charge carriers that capacitively couple charging energy into the coupling device 24 of the CE device 10. Whether inductance or capacitive coupling is used, it will be appreciated that the coupling devices 24, 38 are complementary to each other such that energy from the charging mat battery 36 is coupled through the devices 24, 38 into the CE device battery 22 to wirelessly recharge the CE device battery 22.

As best shown in FIG. 2, while the coupling device 38 of the charging mat 26 is disposed just under the charging surface 28 for optimal coupling with the device 24 of the CE device 10, the charge battery 36 can be disposed just above a bottom thermal layer 40, with the processor 30 disposed between the battery 36 and charge surface 28. The thermal layer 40 may be foam rubber or plastic or fiberglass batting or other thermal insulator with a thickness and material preferably sufficient to insulate a surface such as a table top or user's lap on which the thermal layer 40 is disposed from heat propagating from the CE device 10 and/or internal charging components of the mat 26. In one example, the thermal layer 40 has an R-value of at least three ft²⁻° F.-h/BTU per inch of thickness, and may be half an inch or more thick. The thermal layer 40 may be differently colored than the platen establishing the charge surface 28 or otherwise alpha-numerically labeled “this surface down” to alert the user which surface to place the CE device on to charge it and which surface should be disposed on the table or the user's lap or couch.

Accordingly, it may now be appreciated that the charging mat 26 conveniently may be placed on, e.g., a user's lap and the CE device 10 placed on the charging surface 28 to charge the device 10 while the device 10 is being used, with the thermal layer 40 advantageously shielding the user or surface on which the mat 26 is placed from heat.

FIG. 3 shows that in an alternate embodiment, the charging mat 26 may be disposed in or on a table or desk or other piece of furniture 50. The charging mat 26 may be disposed in a bay formed in the furniture 50 so that the charge surface 28 of the mat 26 is flush with the top surface 52 of the furniture 50.

While the particular INSULATED CHARGING PAD FOR CONSUMER ELECTRONICS (CE) DEVICE is herein shown and described in detail, it is to be understood that the subject matter which is encompassed by the present invention is limited only by the claims.

What is claimed is:

1. Apparatus comprising:
generally flat, parallelepiped-shaped charging mat defining a flat charging surface on which a consumer electronics (CE) device can be disposed to wirelessly recharge a battery in the CE device, the mat containing:
at least one rechargeable charge battery;
at least one transformer connected to the charge battery, the transformer transforming ac power received through a jack from the ac grid into dc power for recharging the rechargeable charge battery;
at least one coupling device receiving electricity from the charge battery, the coupling device being closely juxtaposed with the charge surface such that energy from the charge battery is coupled through the coupling device into the CE device to wirelessly recharge the CE device; and
a bottom thermal layer establishing a thermal insulator with a thickness and material sufficient to insulate a surface on which the thermal layer is disposed from heat propagating from the CE device and internal charging components of the mat, such that the charging mat can be placed on a user's lap and the CE device placed on the charging surface to charge the CE device while the device is being used, with the thermal layer advantageously shielding the user from heat from the CE device and charging mat.

2. The apparatus of claim 1, wherein the thermal layer has an R-value of at least three ft²⁻° F.-h/BTU per inch of thickness.

3. The apparatus of claim 1, wherein the thermal layer is differently colored than the charging surface to alert a user which surface to place the CE device on to charge it and which surface should be disposed on a table or a user's lap.

4. The apparatus of claim 1, wherein the thermal layer is alpha-numerically labeled “this surface down” to alert a user which surface to place the CE device on to charge it and which surface should be disposed on a table or a user's lap.

5. The apparatus of claim 1, wherein the thermal layer is made of foam or fiberglass batting.

6. The apparatus of claim 1, wherein the charging surface is established by a plastic platen.

7. The apparatus of claim 1, wherein the mat includes a processor controlling the transformer.

8. The apparatus of claim 1, wherein the coupling device includes one or more coils which inductively couple charge energy from the charge battery into the CE device.

9. The apparatus of claim 1, wherein the coupling device includes one or more charge carriers that capacitively couple charging energy from the charge battery into the CE device.

10. The apparatus of claim 7, wherein the processor is disposed between the charge battery and charging surface.

11. Assembly comprising:
furniture component defining a top flat surface; and
charging mat defining a charging surface and being disposed in a bay of the furniture component such that the charging surface is flush with the top flat surface, the charging mat being configured to wirelessly recharge a consumer electronics (CE) device placed thereon using inductive or capacitive coupling.

12. The assembly of claim 11, wherein the charging mat includes:
at least one charge battery;
at least one transformer connected to the charge battery, the transformer transforming ac power received through a jack from the ac grid into dc power for recharging the charge battery;
at least one coupling device receiving electricity from the charge battery, the coupling device being closely juxtaposed with the charge surface such that energy from the charge battery is coupled through the coupling device into the CE device to wirelessly recharge the CE device; and
a bottom thermal layer establishing a thermal insulator with a thickness and material sufficient to insulate a surface on which the thermal layer is disposed from heat propagating from the CE device and internal charging components of the mat, such that the charging mat can be placed on a user's lap and the CE device placed on the charging surface to charge the CE device while the device is being used, with the thermal layer advantageously shielding the user from heat from the CE device and charging mat.

13. The assembly of claim 12, wherein the thermal layer has an R-value of at least three ft²⁻° F.-h/BTU per inch of thickness.

14. The assembly of claim 12, wherein the thermal layer is differently colored than the charging surface to alert a user which surface to place the CE device on to charge it and which surface should be disposed on a table or a user's lap.

15. The assembly of claim 12, wherein the thermal layer is alpha-numerically labeled “this surface down” to alert a user which surface to place the CE device on to charge it and which surface should be disposed on a table or a user's lap.

16. The assembly of claim 12, wherein the thermal layer is made of foam or fiberglass batting.

17. Charging mat for recharging a consumer electronics (CE) device placed thereon, comprising:
flat charging surface configured for supporting the CE device;
insulating layer opposed to the charging surface and positionable on a support surface while the CE device is disposed on the charging surface, the insulating layer having an R-value of at least three ft²⁻° F.-h/BTU per inch of thickness;
coupling device closely juxtaposed with the charging surface and configured to inductively and/or capacitively couple charge energy into a battery of the CE device when the CE device is positioned on the charging surface;
charge battery disposed between the charging surface and insulating layer to provide charge energy to the coupling device.

18. The mat of claim 17, wherein the thermal layer is differently colored than the charging surface to alert a user which surface to place the CE device on to charge it and which surface should be disposed on a table or a user's lap.

19. The mat of claim 17, wherein the thermal layer is alpha-numerically labeled “this surface down” to alert a user which surface to place the CE device on to charge it and which surface should be disposed on a table or a user's lap.

20. The mat of claim 17, wherein the thermal layer is made of foam or fiberglass batting.
